(19) United States
(12) Patent Application Publication
(10) Pub. No.: US 2005/0216361 A1
(43) Pub. Date: Sep. 29, 2005

(54) Business transaction processing system

(75) Inventor: Tsuyoshi Fukada, Tokyo (JP)

Correspondence Address: STAAS & HALSEY LLP, SUITE 700, 1201 NEW YORK AVENUE, N.W., WASHINGTON, DC, 20005, US

(73) Assignee: Fidec Corporation, Tokyo (JP)

(21) Appl. No.: 10/951,641

(22) Filed: Sep. 29, 2004

(30) Foreign Application Priority Data
Mar. 26, 2004 (JP) 2004-93208

(51) Int. Cl. G06F 17/60

(52) U.S. Cl. 705/26

(57) ABSTRACT

A business transaction processing system includes a server into which a purchasing information of a stockist, at a time when goods are supplied to a stockist from a plurality of suppliers, is inputted, and a supplier side terminal unit connected to the server through cable communication or wireless communication. The server is provided with a conversion unit for extracting purchasing data relating to an optional supplier of the suppliers from the purchasing information of the stockist and converting the extracted purchasing data into supply information of the optional supplier, and the supply information in the server is indicated on the supplier side terminal unit.

### BACKGROUND OF THE INVENTION

1. Field of The Invention

The present invention relates to a business transaction processing system for improving a business efficiency in transaction or trading business involving suppliers and purchasers (stockists), or export traders and import traders, for example.

2. Related Art

Such system as mentioned above has been conventionally known as disclosed in Japanese Patent Laid-open Publication (KOKAI) No. HEI 10-78993. That is, in such publication, there is a disclosure of “a factoring information processing device provided for a sales transaction processor (trading dealer) and a business processing host provided for each financial institution are connected together through electric communication line, and the factoring information processing device and a terminal unit provided for each supplier firm are also connected to each other through a VAN”. In addition, this factoring information processing device is provided with information processing means and communication control means concerning the factoring business, and data relating to a settlement procedure of credit among such factoring information processing device, business processing host and terminal unit are transmitted and/or received thereamong via the electric communication line and VAN mentioned above.

According to such system, cost payment to the supplier can be any time done as occasion demands, which makes it possible to completely abolish bills (promissory notes) and to promptly process a lot of data with less labor.

However, in such conventional system, it is obliged for the supplier's firm to carry out a management of account receivable-trade (amount) and, on the other hand, it is also obliged for the purchaser's firm to carry out a management of account payable-trade (amount) , respectively. Therefore, from the viewpoint of business efficiencies in all the trading firms concerned, duplicated works, operations, managements and the like exist, thus being inconvenient and not efficient.

### SUMMARY OF THE INVENTION

The present invention was conceived in consideration of such defects or inconveniences encountered in the prior art mentioned above. And an object of the present invention is to provide a business transaction processing system capable of performing management workings or operations concerning account receivable and account payable between respective firms or traders at an improved efficiency.

This and other objects can be achieved according to the present invention by providing, in one aspect, a business transaction processing system comprising:

a server into which a purchasing information of a stockist at a time when goods are supplied to the stockist from a plurality of suppliers is inputted; and

a supplier side terminal unit connected to the server through cable communication or wireless communication, the server being provided with a conversion unit for extracting purchasing data relating to optional supplier of the suppliers from the purchasing information of the stockist and converting the extracted purchasing data into supply information of the optional supplier, wherein the supply information in the server is indicated on the supplier side terminal unit.

In another aspect of the present invention, there is provided a business transaction processing system comprising:

a server into which a purchasing information of each stockist at a time when goods are supplied to a plurality of stockists from a supplier is inputted; and

a supplier side terminal unit connected to the server through cable communication or wireless communication, the server being provided with a conversion unit for extracting purchasing data relating to the supplier from a plurality of purchasing information of the plurality of stockists and converting the extracted purchasing data into supply information of the supplier, wherein the supply information in the server is indicated on the supplier side terminal unit.

In another aspect of the present invention, there is provided a business transaction processing system comprising:

a server into which a purchasing information of each stockist at a time when goods are supplied to a plurality of stockists from a plurality of suppliers is inputted; and

a supplier side terminal unit connected to the server through cable communication or wireless communication, said server being provided with a conversion unit for extracting purchasing data relating to an optional supplier of said suppliers from the purchasing information of the plurality of stockist and converting the extracted purchasing data into supply information of the optional supplier, wherein the supply information in the server is indicated on the supplier side terminal unit.

In the above aspects, it may be preferred that an offer to sell account receivable of the supplier relating to the stockist based on the supply information is transmitted from the supplier side terminal unit to the server, and the server is provided with a confirmation unit for confirming properness of that offer.

It may be also preferred that sales information at a time when the stockist sells the goods is inputted into the server, and said confirmation unit of the server decides payment to the supplier with respect to the offer to sell the account receivable in accordance with the sales information.

Furthermore, it may be preferred that when the stockist sells the goods, an offer to receive a cost due to sales of the stockist is transmitted to the server from the stockist side terminal unit, and the server is provided with a confirmation unit for confirming properness of that offer.

The sales information at a time when the stockist sells the goods is inputted into the server, and the confirmation unit of the server decides payment to the stockist with respect to the offer to receive the cost due to the sales of the stockist in accordance with the sales information.

In a further aspect of the present invention, there is also provided a business transaction processing system comprising:

a server into which import offer information from an import trader at a time when the import trader offers importing of goods to an export trader, and information of inspection result of goods brought into a predetermined place of an exporting country, are inputted; and

an export trader side terminal unit operatively connected to the server for receiving an offer to sell an export credit,

the server being provided with a confirmation unit for comparing content of the offer with the goods inspection result information and making a decision of payment.

In a still further aspect, there is also provided a business transaction processing system comprising:

a server into which import offer information from an import trader, at a time when importing of goods is offered from the import trader to an export trader, is inputted; and

an export trader side terminal unit connected to the server through cable communication or wireless communication,

the server being provided with a conversion unit for extracting exporting data relating to the export trader from a plurality of import offer informations relating to the import trader and converting the extracted exporting data into exporting information of the export trader, wherein the exporting information in the server is indicated on the export trader side terminal unit.

According to the present invention of the aspects mentioned above, by utilizing the purchasing information relating to the stockist and extracting the purchasing data relating to an optional stockist, which is then converted into the supply information of the supplier, it becomes not necessary to separately input the account receivable-trade for the supplier, whereby it becomes possible to manage the account receivable-trade of the supplier and to hence reduce labor of the supplier for such management.

Furthermore, as mentioned above, by utilizing the purchasing informations relating to a plurality of stockists and extracting the purchasing data relating to the supplier from the plurality of purchasing informations, which are then converted into the supply information of the supplier, it becomes not necessary to separately input the account receivable-trade for the supplier, whereby it becomes possible to manage the account receivable-trade of the supplier and to hence reduce labor of the supplier for such management.

In addition, according to the preferred embodiments of the above aspects, the offer to sell the account receivable of the supplier relating to the stockist can be transmitted to the server from the supplier side terminal unit in accordance with the supply information, and the confirmation unit is provided for the server to confirm the properness of the offer, so that it is not necessary for the supplier to prepare his own supply information and it is possible for the supplier to offer the selling of the account receivable with reference to the supply information. Thus, more proper offering can be done. Moreover, the supplier can receive the payment due to such offering to thereby recover the expense before the due date of the expense receivable (account receivable-trade) of the goods from the stockist, making it possible to perform the fund management without borrowing.

Furthermore, according to the other features of the present invention, the sales information, at a time when the stockist sells the goods, is inputted into the server, and the server is provided with a confirmation unit so as to decide the payment to the supplier with respect to the offer from the supplier in accordance with the sales information. Accordingly, the risk that a sales transaction processor (trading dealer) cannot recover the expense from the stockist, after the payment of the predetermined amount of money by the sales transaction processor to the supplier, can be minimized.

Still furthermore, when the stockist sells the goods, the offer to receive the cost due to sales of the stockist is transmitted to the server from the stockist side terminal unit, and the server is provided with a confirmation unit for confirming properness of that offer. Accordingly, the stockist can receive the payment in accordance with the offer, and hence, can recover the cost before the due date for the payment of the cost of goods from a buyer, making it possible to perform the fund management without borrowing.

Still furthermore, according to the preferred embodiment of the present invention, the sales information at a time when the stockist sells the goods is inputted into the server, and the confirmation unit of the server decides the payment to the stockist with respect to the offer to receive the cost due to the sales of the stockist in accordance with the sales information. Accordingly, the risk that the sales transaction processor cannot recover the predetermined amount of money from the buyer, after the payment of the predetermined amount of money of the sales transaction processor to the stockist, can be minimized.

Moreover, according to the features of further aspect of the present invention, the business transaction processing system comprises: a server into which import offer information from an import trader at a time when the import trader offers importing of goods to an export trader is inputted and into which information of inspection result of goods brought into a predetermined place of an exporting country by the export trader; and an export trader side terminal unit operatively connected to the server for receiving an offer to sell an export credit, in which the server is provided with a confirmation unit for comparing content of the offer with the goods inspection result information and making a decision of payment. According to such features, the import trader can reduce the cost for establishing the letter of credit (L/C), and in addition, the complicated importing office work can be reduced. Furthermore, the export trader can receive the payment just after the inspection of goods, so that the money can be early utilized as fund, thus being effectively advantageous for the fund management.

Still furthermore, according to the business transaction processing system of still further aspect comprises: a server into which an importing offer information of an import trader at a time when importing of goods is offered from the import trader to an export trader is inputted; and an export trader side terminal unit connected to the server through cable communication or wireless communication, in which the server is provided with a conversion unit for extracting exporting data relating to the export trader from a plurality of importing offer information relating to the import trader and converting the extracted exporting data into exporting information of the export trader, and the exporting information in the server is indicated on the export trader side terminal unit.

Accordingly, it is not necessary for the export trader to input the data concerning the account receivable for the export trader, and the export trader can manage the account receivable-trade owned by the export trader himself, thus extremely reducing the labor and works for such management of the export trader.

It is to be noted that the nature and further characteristic features of the present invention will be made more clear from the following descriptions made with reference to the accompanying drawings.

### BRIEF DESCRIPTION OF THE DRAWINGS

In the accompanying drawings:

FIG. 1 is a diagram showing relationships among suppliers, purchasers (stokists) and buyers, respectively, according to a first embodiment of the present invention;

FIG. 2 is a diagram showing a trading conditions or relationships among the suppliers, the stockists and the buyers according to the first embodiment of the present invention;

FIG. 3 is a flowchart concerning the first embodiment of the present invention mentioned above;

FIG. 4 is an illustration showing a server according to the first embodiment;

FIG. 5 is a view showing a purchasing content by the stockist according to the first embodiment;

FIG. 6 is a view showing data of the respective stockists according to the first embodiment;

FIG. 7 is a view showing data of the respective suppliers according to the first embodiment; and

FIG. 8 is a diagram showing a trading conditions or relationships among an exporter, an importer etc. according to a second embodiment of the present invention.

### DESCRIPTION OF THE PREFERRED EMBODIMENT

The present invention will be described hereunder through descriptions of the preferred embodiments with reference to the accompanying drawings.

[First Embodiment]

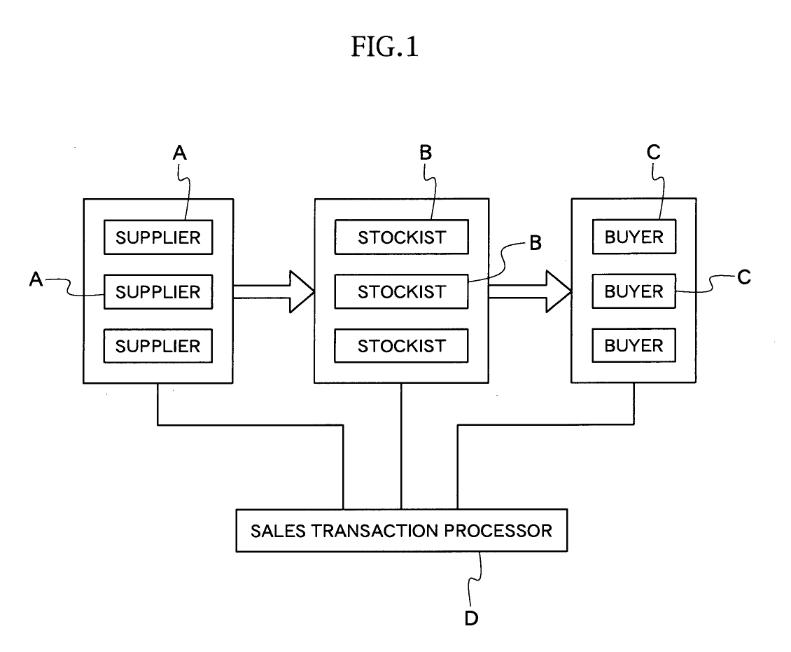

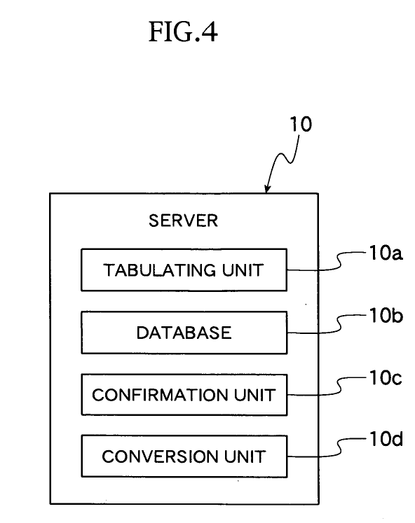

With reference to FIGS. 1 to 7, the first embodiment of the business transaction (i.e., trading) processing system of the present invention will be explained.

This business transaction processing system is a system for achieving an improved efficiency in business operations or workings carried out among or between a plurality of suppliers A, stockists B and buyers C, and herein, as shown in FIG. 1, the embodiment is explained in view of the suppliers A, the stockists B and the buyers C, which are existing at three locations, respectively, and one sales transaction processor (i.e. trading dealer)D.

For example, in an occasion where stockists B receive supplies of goods or products from the suppliers A, an account payable is caused to the stockists B in relation to the suppliers A, and an account receivable is, on the other hand, caused to the suppliers A in relation to the stockists B.

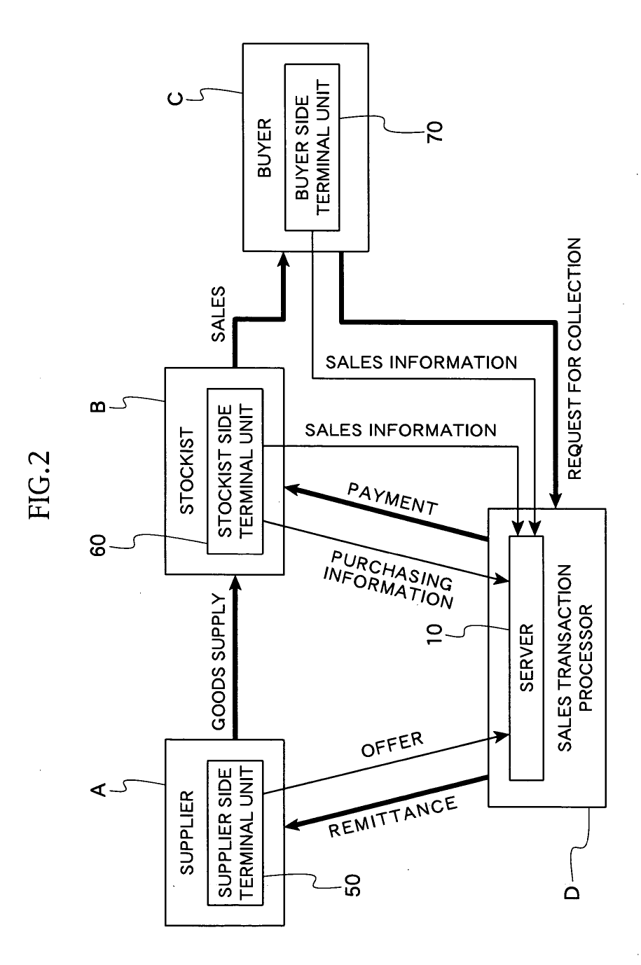

FIG. 2 shows the relationship among one set of supplier A, stockist B and buyer C and the sales transaction processor D, which may be called merely trading dealer D hereinlater. That is, referring to FIG. 2, reference numeral 10 represents a server 10 provided for the trading dealer D, and a supplier side terminal unit 50 provided for the supplier A, a stockist side terminal unit 60 provided for the stockist B and a buyer side terminal unit 70 provided for the buyer C are connected to this server 10 via electric communication lines or means such as the Internet or Internets, not shown.

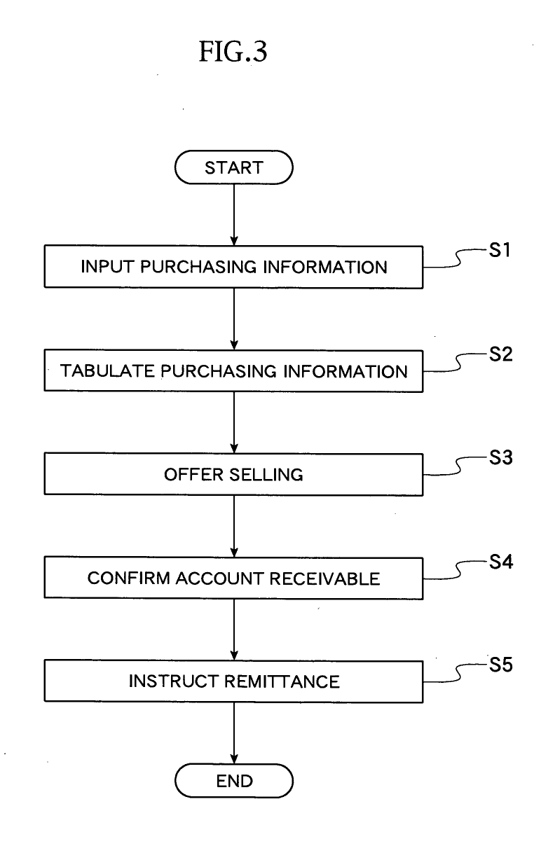

The processing flow thereamong through the described electric communication lines will be explained hereunder with reference to the flowchart of FIG. 3.

First, in step S1, the stockist B who receives the supply of products or goods from the supplier A inputs, into the stockist side terminal unit 60, the purchase information or data for performing management of deadline date for payment and official transaction therefor with respect to account payable caused by the supply of the goods.

In this step S1, the supplier A provides the goods to a plurality of stockists B, and such goods are supplied continuously day by day, for example, and accordingly, the purchase information are then continuously stored.

In the conventional technology, for example, such stored information is taken out from database (DB) on the deadline date of the purchase data set by every predetermined term such as the end of the month. The thus taken-out data is utilized by each stockist B for the payment processing or treatment of the account payable-trade (amount), to the supplier A to whom the stockist B has his business trading or like.

In this system, the purchase information, that is stored in the database of the stockist side terminal unit 60 of each of the stockists B, is transmitted to the server 10 before the deadline date. Further, it may de desired that this transmitting of the purchase information to the server 10 is shorter than an interval between the deadlines of the purchase informations of the respective stockists B, and more preferably, it will be desired to carry out such transmitting every day, whereby the purchase information in the server 10 can be renewed and the latest purchase information can be always kept therein.

The purchase information, i.e., information concerning account payable is transmitted from the stockist side terminal unit 60 to the server 10 of the trading dealer D and a plurality of account payable (purchase information) possessed by the respective stockists B are collected and tabulated at tabulating unit 10a in the server 10 and the tabulated data are inputted into database 10b. Through such processes, the trading dealer D can grasp the account payable condition of each stockist B (step S2).

Further, herein, it is stated that the purchase information is transmitted from the stockist side terminal unit 60 to the server 10 of the trading dealer D, but it may be possible to input the purchase information into the database 10b on the server 10 in accordance with documents of purchasing information sent from the stockist B and then to send such data to the stockist side terminal unit 60 via the Internet or like. It may be also possible for the stockist B to access the server 10 from the stockist side terminal unit 60 so as to brose or download the account payable-trade management data. According to such processing, the stockist B can manage own account payable-trade without making excess labor.

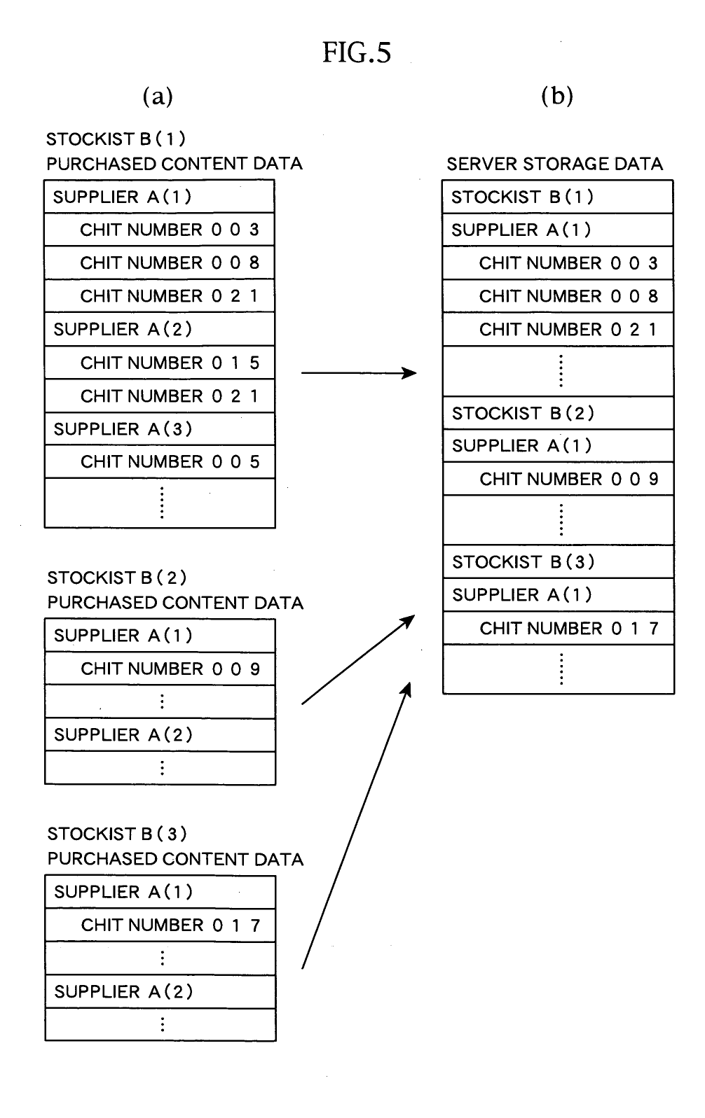

FIG. 5 shows data storage conditions of the purchasing information stored in the database of the stockist side terminal unit 60 of each of the stockists B(1), B(2), B(3) and of data in the database 10b of the server 10 in which these purchase information are transmitted and tabulated.

With reference to FIG. 5, identification information of the suppliers A who supply goods or products is written on the database of the stockist side terminal units 60 of the stockists B, respectively, and contents and details of the goods supplied by the respective suppliers A are also written on the database. These details include goods supplying date, goods supply quantity, unit price thereof, total price and the like. The information of these details of the goods is recorded together with chit numbers of the suppliers A.

In a certain case such that one supplier A supplies different kinds of goods on different days, a plurality of different chit numbers of this one supplier A will be stored on the database 10b of the stockist B.

In the server 10 into which the purchasing information is inputted from the stockist side terminal unit 60, as shown in FIG. 5, the purchase information is separated and stored respectively with respect to the stockists B(1), B(2), B(3). Then, in the case where the purchase information is transmitted every day from the stockist side terminal unit 60 to the server 10, this purchase information, as account payable data, exists in the database 10b of the server 10 just after the supply of the goods from the supplier A.

Thus, the sales transaction processor (i.e., trading dealer) D having the server 10 can grasp all the contents of the account payable-trades of the respective stockists B(1), B(2), B(3), whereby the supplier A can sell his own account receivable for the specific stockist B to the trading dealer D without waiting for the payment of the cost by the stockist B for the supplied goods.

That is, as shown in FIG. 5, in step S3, the supplier A(1) having a business relation to the stockist B(1) transmits an offer to sell the account receivable concerning his own chit numbers (008) and (021) to the server 10 from the supplier side terminal unit 50. In this step, the identification information of the supplier A(1) and his chit numbers are inputted into the server 10, and in the server 10, the existence of this account receivable and its contents can be confirmed by a confirmation unit 10c or like (step S4) It is of course identical to a case in which other supplier A(2) or A(3) offers selling of his own chit numbers.

Then, in the server 10, when the existence of the supplier A(1) and the offered account receivable is confirmed, it will be determined to buy such account, and it is instructed that the buying amount of money in the fund for buying such account owned by the trading dealer D is to be transmitted to the supplier A(1) (step S5).

That is, the server 10 instructs the trading dealer D to transmit the amount of money from his buying cash account to the supplier A(1), thus completing the account receivable buying processing.

Further, the determination of the buying amount of money can be decided by the server 10 in accordance with the data, preliminarily inputted therein, concerning, for example, : remaining number of days to scheduled deadline for payment of the stockist B from the day on which the supplier A offered to sell the account receivable; face value of this account receivable; scale of operation and financial condition of the stockist B as a debtor of this account; frequency of using of this system by the supplier A offering the selling of this account, and the like.

As mentioned above, the server 10 checks the fact whether there is an offer (or there is no offer) of the account receivable from the supplier A with respect to the purchasing information (i.e., account payable data) stored during the predetermined period, and the server 10 performs the buying processing with respect only to the offered one. Then, after elapsing of a predetermined waiting period of buying the account with respect to such purchasing information, total amount of the account receivable obtained is calculated for each of the respective stockists B(1), B(2), B(3), and the calculated results are treated as total bill data for each stockist B. Moreover, the server 10 extracts, from the stored purchasing information, a purchasing information with respect to the account receivable to which any selling was not offered, and the extracted purchasing information is returned to the stockist side terminal units 60 of the respective stockists B as unpaid account payable data.

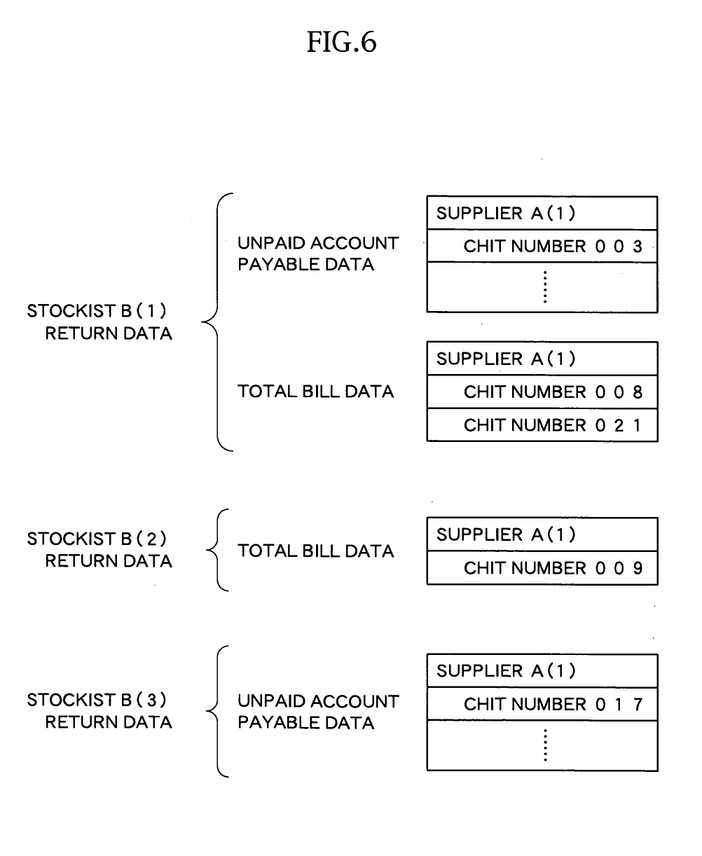

For example, as shown in FIG. 6, with respect to the purchasing information corresponding to the chit numbers of (008) and (021) of the supplier A(1) to whom the buying is decided, prices of goods (account receivable) on these chits are summed up and this data is sent to the stockist B(1) as total bill (demand) data. On the other hand, with respect to the purchasing information corresponding to the chit number of (003) of the supplier A(1), to which any selling was not offered, this data is returned to the stockist side terminal unit 60 of the stockist B(1) as the unpaid account payable data.

Furthermore, in a case where it is decided to buy the account receivable to all the purchasing informations supplied from the stockist B(2), the sum of the prices of goods (account receivable) on these chits is deemed to be the total bill data to the stockist B(2), and hence, there does no longer exist any unpaid account payable data to be returned to the stockist B(2).

Still furthermore, with respect to a plurality of purchasing information supplied from the stockist B(3), in a case where even one offer for selling the account receivable was not made, any total bill data is not prepared, and all the purchasing information is returned to the stockist B(3) as the unpaid account payable data.

Further, a plurality of purchasing information from the respective stockists B(1), B(2), B(3), as shown in (a) of FIG. 5, are transmitted to the server 10, which are then tabulated with respect to the respective stockists as shown in (b) of FIG. 5. Then, on the conversion unit 10d of the server 10, purchasing data relating to an optional supplier A is extracted from the thus tabulated purchasing information, and the extracted purchasing data is converted into supply information for that optional supplier A.

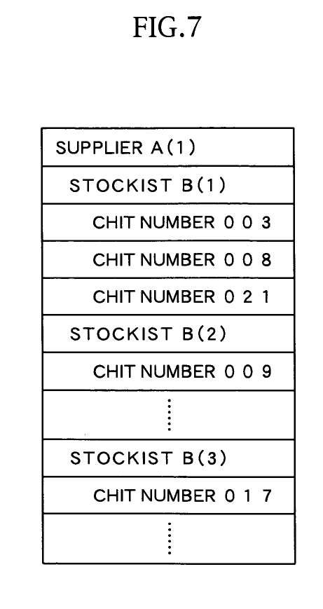

That is, for example, as shown in FIG. 7, with the case of the supplier A(1) , the information or data of the chit Nos. (003), (008), (021) of the stockist B(1), that of the chit No. (009) of the stockist B(2) and that of the chit No. (017) of the stockist B(3) are collected and tabulated. These tabulated information or data are referred to as “supply information”. Of course, the supply information of the other suppliers A(2), A(3) can be automatically prepared by substantially the same or identical manner.

Such supply information is transmitted to the supplier side terminal unit 50 from the server 10, or may be referred to through a dedicated home page (HP), for example. That is, the supplier A who wants to brose the HP can access it from the supplier side terminal unit 50 and then inputs his ID and password for identifying the contracted supplier A, thus obtaining their own supply information.

According to such system, although the purchasing informations transmitted to the server 10 from the respective stockists B are arranged for the respective stockists B, as shown in FIG. 5(b), such purchasing information is not directly applied as it is as the supply information of the supplier A. Because of this reason, herein, the chits are collected and tabulated for each of the suppliers A by means of the conversion unit 10d of the server 10 as shown in FIG. 7. Especially, in the case where one supplier A supplies goods to a plurality of stockists B, the data concerning the supplier A is tabulated on the basis of the purchasing information of the respective stockists B.

Therefore, the management of the account payable-trade of the stockists B can be done in accordance with a plurality of informations of a plurality of stockists B, and in addition, by utilizing such plural purchasing informations and tabulating the informations, the supply information of the supplier A can be managed, whereby the supplier A can manage the account receivable-trade.

Hereunder, a case that the stockist B sells goods to the buyer C will be explained.

In such case, selling information of the fact that the stockist B sells goods to the buyer C is transmitted to the server 10 from a buyer side terminal unit 70. Further, although this selling information may be referred to as purchasing information for the buyer C, this will be totally explained herein as sales information.

Based on this sales information, sales amount of the stockist B can be instantly known. In this server 10, it can easily be figured out how much fund is pooled in a deposit account of each of the stockists B. Further, it may be possible to transmit the sales information to the server 10 from the stockist side terminal unit 60. Furthermore, more proper sales information is obtainable by obtaining the sales information from both of the buyer side terminal unit 70 and stockist side terminal unit 60 and comparing them with each other.

Accordingly, through the reference to the sales data (sales information) of the stockist B, the confirmation unit 10c decides whether the buying processing for buying the account receivable offered by the supplier A is to be executed or not. Of course, the payment to the supplier A may be executed as mentioned above with no reference to the sales information.

Further, when the stockist B sells goods, it is made possible to transmit an offer to receive a cost due to the sales by the stockist B to the server 10 from the stockist side terminal unit 60, and it is then discriminated and confirmed whether this offer is to be properly acceptable or not by the confirmation unit 10c of the server 10. That is, in the confirmation unit 10c, based on such sales information, the payment to the stockist B based on the offer of stockist B to receive the cost due to the sales by the stockist is decided.

According to such decision of the payment, the sales transaction processor D pays a predetermined amount of money to the supplier A, and also, pays to the stockist B some amount of money that is several % less than the sales amount. Then the sales transaction processor D recovers the sales amount from the buyer C.

According to the system of the present invention, since the amount of payment to the supplier A and the stockist B is decided in accordance with the sales information, risk or possibility, for the sales transaction processor D, of not recovering or receiving the money from the buyer C can be minimized possibly small after the payment of the predetermined amount of money from the sales transaction processor D to the supplier A and the stockist B.

Moreover, the stockist B can recover the cost due to the sales before the due date for the payment as the amount of money for goods from the buyer C by receiving the payment due to the offer, and hence, the stockist B can execute fund procurement by himself without receiving any other debt finance.

On the other hand, in the case where the stockist B sells goods to the consuming public, selling data is stored in a register installed at a retail store, and in the case of a plurality of retail stores existing, sales amount in the respective retail stores can be instantly known. Accordingly, by connecting the register to the stockist side terminal unit 60 or server 10, such sales data can be referred to through the display unit. Thus, it can be also easily known how much fund is pooled in the deposit account of each of the respective stockists B. Accordingly, the payment may be also decided in accordance with the sales data (i.e., sales information) of the stockist B.

As mentioned above, according to the system of the present invention, by utilizing the sales information, the risk of the sales transaction processor D can be extremely reduced, and moreover, in the case of the payment to the supplier A and/or stockist B, the payment will be decided without referring to such sales information.

[Second Embodiment]

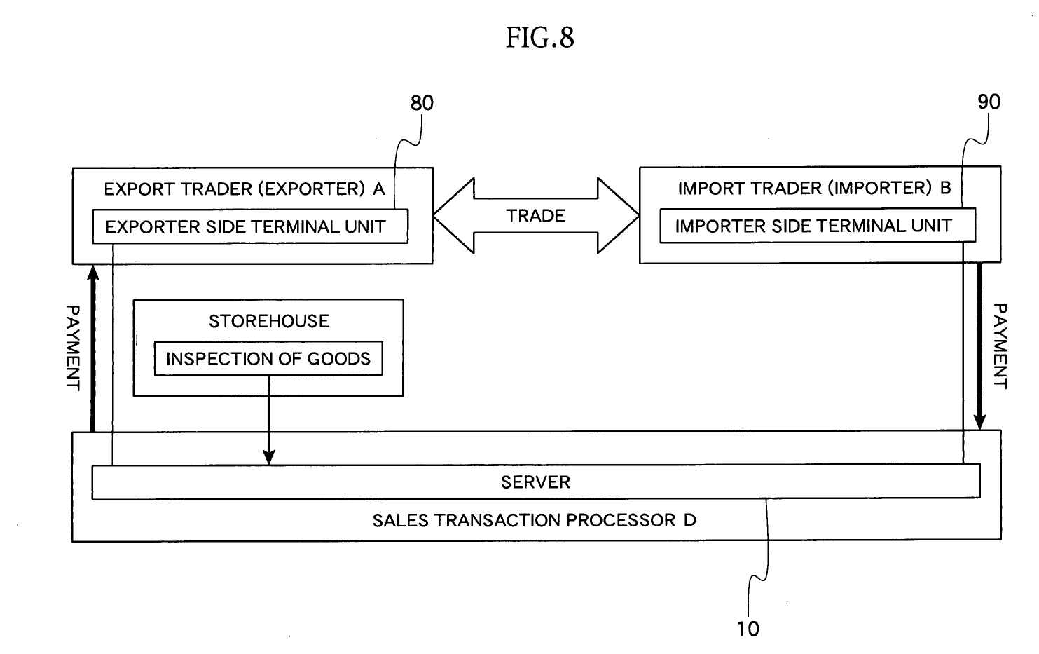

FIG. 8 represents a second embodiment according to the present invention.

This second embodiment relates to a system for performing business treatments or processings caused during the tradings of export traders A or import traders B at a time of importing goods or like.

With reference to FIG. 8, the import trader B (importer B) has a communication with an exporter side terminal unit 80 from an importer side terminal unit 90 to communicate with the exporter A about his desire to import goods he wants to purchase. Of course, such sounding (offer) may be made in writing or orality.

Thereafter, the import trader B transmits import offer information to the server 10 through the importer side terminal unit 90.

On the other hand, the export trader A (exporter A) brings the offered goods in a storehouse or distribution firm, in which the goods are subjected to inspection. The result of such inspection of the goods is inputted into the server 10. The goods inspection result may indicate several situations, for example, such as all the goods are stored intact, some goods are not yet stored, or some goods are found defective.

Such inspection result is inputted into the server 10 as goods inspection information, and then, is compared with the exporting information corresponding to the purchasing information mentioned hereinbefore in the confirmation unit 10c. According to such processing, the import offer information is rewritten as corrected import information based on the properly stored goods and then stored in the database 10b. This corrected import information is transmitted to the importer side terminal unit 90 and the exporter side terminal unit 80.

Then, it becomes possible for the export trader A to sell a specific export credit owned by the export trader A to the sales transaction processor (trading dealer) D in accordance with the corrected import information without waiting the payment of the cost for the goods from the import trader B.

That is, in the case where the export trader A transmits, to the server 10 from the exporter side terminal unit 80, the offer to sell the account receivable with respect to all the goods which are judged to be not defective (proper) or to some of the goods, the server 10 can immediately confirm the existence and contents of the export credit mentioned above based on the inputted identification information and chit number of the export trader A.

The server 10, thereafter, decides the buying of that credit after the confirmation of the existence of the export trader A and the export credit offered by him, and then remits the amount of the credit, to the export trader A, from the credit buying fund of the sales transaction processor D.

That is, the server 10 indicates, the remittance to the export trader A from the buying fund account of the sales transaction processor D, and then, the export credit buying processing has been completed.

Further, the corrected import information may be utilized for the management of the account receivable-trade of the export trader A by converting the corrected import information in the converting unit 10d of the server 10 in a manner identical to that mentioned with respect to the first embodiment.

According to such processings, the import trader B can reduce the cost of establishing a letter of credit (L/C) , and in addition, the import trader B can also reduce his complicated import office work. That is, in recent years, in the settlement in international trade, an L/C issued by a bank has been generally utilized in order that the export trader A can surely recover the exporting cost. For utilizing such L/C, however, the import trader B has first to establish an L/C in a financial institution, which will involve much money, complicated proceeding, providing of guarantee, and the like, thus increasing a burden to the import trader B.

According to the present invention, however, the goods are brought into a storehouse in an exporting country and the payment can be performed after the completion of the inspection of the goods, so that it is not necessary to issue any L/C. Accordingly, the L/C establishment cost can be reduced, and the preparation of any shipping bill is not required, thus effectively reducing the complicated importing office work involved by these matters.

Furthermore, it becomes possible for the export trader A to receive the payment just after the inspection of the goods, so that the payment can be promptly utilized as fund, thus being effective for the fund management. That is, usually, the export trader A has a strong desire to recover the exporting cost as early as possible for the improved smooth fund management because the cost recovery from the export trader A is made after the shipping of the goods in spite of the fact that the cost of the goods has to be beforehand paid to the supplier of the goods.

However, in a conventional system, the recovery of the cost, in a case of utilizing the L/C which is generally used for the settlement in the export/import trading, has been done after bringing the goods into a storehouse, inspecting the goods, shipping the goods, receiving the bill of lading issued by a ship firm, and bringing of the shipping bill into the financial institute, these processes or treatments requiring much time and labor for the recovery.

According to the present invention, on the contrary, the requirement for the export trader A of prompt funding can be performed by bringing the goods into a storehouse in the exporting country by the export trader A, selling the export credit after the inspection of the goods and then recovering the cost. Therefore, the export trader A can recover the fund in an early stage to thereby improve the fund management, and as a result, the turnover of fund can be improved, so that the fund in hand can be effectively utilized, increasing the sales efficiency.

It is to be noted that the present invention is not limited to the described embodiments and many other changes and modifications may be made without departing from the scopes of the appended claims.

1. A business transaction processing system comprising:
a server into which a purchasing information of a stockist at a time when goods are supplied to the stockist from a plurality of suppliers is inputted; and
a supplier side terminal unit connected to the server through cable communication or wireless communication,
said server being provided with a conversion unit for extracting purchasing data relating to an optional supplier of said suppliers from the purchasing information of the stockist and converting the extracted purchasing data into supply information of the optional supplier, wherein the supply information in the server is indicated on the supplier side terminal unit.

2. A business transaction processing system comprising:
a server into which a purchasing information of each stockist at a time when goods are supplied to a plurality of stockists from a supplier is inputted; and
a supplier side terminal unit connected to the server through cable communication or wireless communication,
said server being provided with a conversion unit for extracting purchasing data relating to the supplier from a plurality of purchasing information of the plurality of stockists and converting the extracted purchasing data into supply information of the optional supplier, wherein the supply information in the server is indicated on the supplier side terminal unit.

3. A business transaction processing system comprising:
a server into which a purchasing information of each stockist at a time when goods are supplied to a plurality of stockists from a plurality of suppliers is inputted; and
a supplier side terminal unit connected to the server through cable communication or wireless communication,
said server being provided with a conversion unit for extracting purchasing data relating to an optional supplier of said suppliers from the purchasing information of the plurality of stockist and converting the extracted purchasing data into supply information of the optional supplier, wherein the supply information in the server is indicated on the supplier side terminal unit.

4. A business transaction processing system according to claim 1 or 2 or 3, wherein an offer to sell account receivable of the supplier relating to the stockist based on the supply information is transmitted from the supplier side terminal unit to the server, and the server is provided with a confirmation unit for confirming properness of said offer.

5. A business transaction processing system according to claim 4, wherein a sales information, at a time when the stockist sells the goods, is inputted into the server, and said confirmation unit of the server decides payment to the supplier with respect to the offer to sell the account receivable in accordance with the sales information.

6. A business transaction processing system according to claim 1 or 2 or 3, wherein when the stockist sells the goods, an offer to receive a cost due to sales of the stockist is transmitted to the server from the stockist side terminal unit, and the server is provided with a confirmation unit for confirming properness of said offer.

7. A business transaction processing system according to claim 6, wherein sales information, at a time when the stockist sells the goods, is inputted into the server, and said confirmation unit of the server decides payment to the stockist with respect to the offer to receive the cost due to the sales of the stockist in accordance with the sales information.

8. A business transaction processing system comprising:
a server into which import offer information from an import trader at a time when the import trader offers importing of goods to an export trader, and information of inspection result of goods brought into a predetermined place of an exporting country, are inputted; and
an export trader side terminal unit operatively connected to the server for receiving an offer to sell an export credit,
said server being provided with a confirmation unit for comparing content of the offer with the good inspection result information and making a decision of payment.

9. A business transaction processing system comprising:
a server into which import offer information from an import trader, at a time when importing of goods is offered from the import trader to an export trader, is inputted; and
an export trader side terminal unit connected to the server through cable communication or wireless communication,
said server being provided with a conversion unit for extracting exporting data relating to the export trader from a plurality of import offer information relating to the import trader and converting the extracted exporting data into exporting information of the export trader, wherein the exporting information in the server is indicated on the export trader side terminal unit.
